(19) United States
(12) Patent Application Publication
(10) Pub. No.: US 2009/0106678 A1
(43) Pub. Date: Apr. 23, 2009

(54) SYSTEM AND METHOD FOR AIDING CONCEPTUAL ORGANIZATION BY CHILDREN

(75) Inventors: Mary Chase, Portland, OR (US); John Cromett, Portland, OR (US); Donald Jeffrey Helfgott, Portland, OR (US); Leslie Linnea Johnsson, Portland, OR (US); Jason Kunkel Stafford, Portland, OR (US); Mona L. Westhaver, Portland, OR (US)

Correspondence Address: KOLISCH HARTWELL, P.C., 200 PACIFIC BUILDING, 520 SW YAMHILL STREET, PORTLAND, OR, 97204, US

(73) Assignee: INSPIRATION SOFTWARE, INC., Beaverton, OR (US)

(21) Appl. No.: 12/235,238

(22) Filed: Sep. 22, 2008

Related U.S. Application Data
(63) Continuation of application No. 10/779,179, filed on Feb. 12, 2004, now abandoned.

(51) Int. Cl. G06F 3/048

(52) U.S. Cl. 715/764

(57) ABSTRACT

A system and method for assisting children in organizing and categorizing information, includes a program that includes a dual graphical and non-graphical user-interface that is operable by a child to create and identify a variety of concepts, and to organize and arrange those concepts in a non-graphical hierarchy by creating spatial associations using the graphical user-interface.

### CROSS REFERENCE TO RELATED APPLICATIONS

This application is a continuation of U.S. patent application Ser. No. 10/779,179, filed Feb. 12, 2004, which is a continuation-in-part of U.S. patent application Ser. No. 09/952,476, filed Sep. 12, 2001 and entitled “System and Method for Aiding Conceptual Organization by Children” which claims priority to U.S. Provisional Patent Application Ser. No. 60/231,780, filed on Sep. 12, 2000 and entitled “System and Method for Aiding Conceptual Organization in Children”.

### BRIEF DESCRIPTION OF THE FIGURES

FIG. 1 is a screen print of an exemplary graphical user-interface according to the present invention.

FIG. 2 is a screen print of an exemplary non-graphical user-interface corresponding to the graphical user-interface of FIG. 1.

FIG. 3 is an exemplary graphical workspace according to the present invention showing a graphical arrangement of grouping objects and concept symbols.

FIG. 4 is an exemplary textual workspace showing a logical arrangement of grouping objects and concept symbols corresponding to the graphical arrangement of FIG. 3.

FIG. 5 is an exemplary graphical workspace according to the present invention showing an alternative graphical arrangement of grouping objects and concept symbols.

FIG. 6 is an exemplary textual workspace showing a logical arrangement of grouping objects and concept symbols corresponding to the alternative graphical arrangement of FIG. 5.

FIG. 7 is an exemplary graphical workspace according to the present invention showing another alternative graphical arrangement of grouping objects and concept symbols.

FIG. 8 illustrates an exemplary textual workspace showing a logical arrangement of grouping objects and concept symbols corresponding to the other alternative graphical arrangement of FIG. 7.

FIG. 9 is an exemplary graphical workspace according to the present invention showing a further alternative graphical arrangement of grouping objects and concept symbols.

FIG. 10 is an exemplary textual workspace showing a logical arrangement of grouping objects and concept symbols corresponding to the further alternative graphical arrangement of FIG. 9.

FIG. 11 is an exemplary graphical workspace according to the present invention showing a further alternative graphical arrangement of grouping objects and concept symbols.

FIG. 12 is an exemplary textual workspace showing a logical arrangement of grouping objects and concept symbols corresponding to the further alternative graphical arrangement of FIG. 11.

FIG. 13 is an exemplary graphical workspace according to the present invention showing a further alternative graphical arrangement of grouping objects and concept symbols.

FIGS. 14a and 14b illustrate an exemplary textual workspace showing a logical arrangement of grouping objects and concept symbols corresponding to the further alternative graphical arrangement of FIG. 13.

### DISCLOSURE OF THE INVENTION

The present invention provides a system for assisting children in organizing and categorizing information such as ideas, concepts, objects, etc. The exemplary system is implemented as a software application program executable by a standard personal computer device. The program provides a dual graphical and non-graphical user-interface that is operable by a child to create and identify a variety of concepts, and to organize and arrange those concepts in a non-graphical hierarchy by creating spatial associations using the graphical user-interface.

It will be appreciated that the invention may be configured for use on any selected computer system including personal computers, workstations, personal digital assistants, client terminals, etc. Furthermore, the invention may be implemented in any programming language or environment suitable for execution by the selected computer system. Thus, while the invention is described below in the context of one exemplary implementation which is executable on a PC-type personal computer running a WINDOWS® operating system, it will be understood that the invention is not limited to that particular implementation.

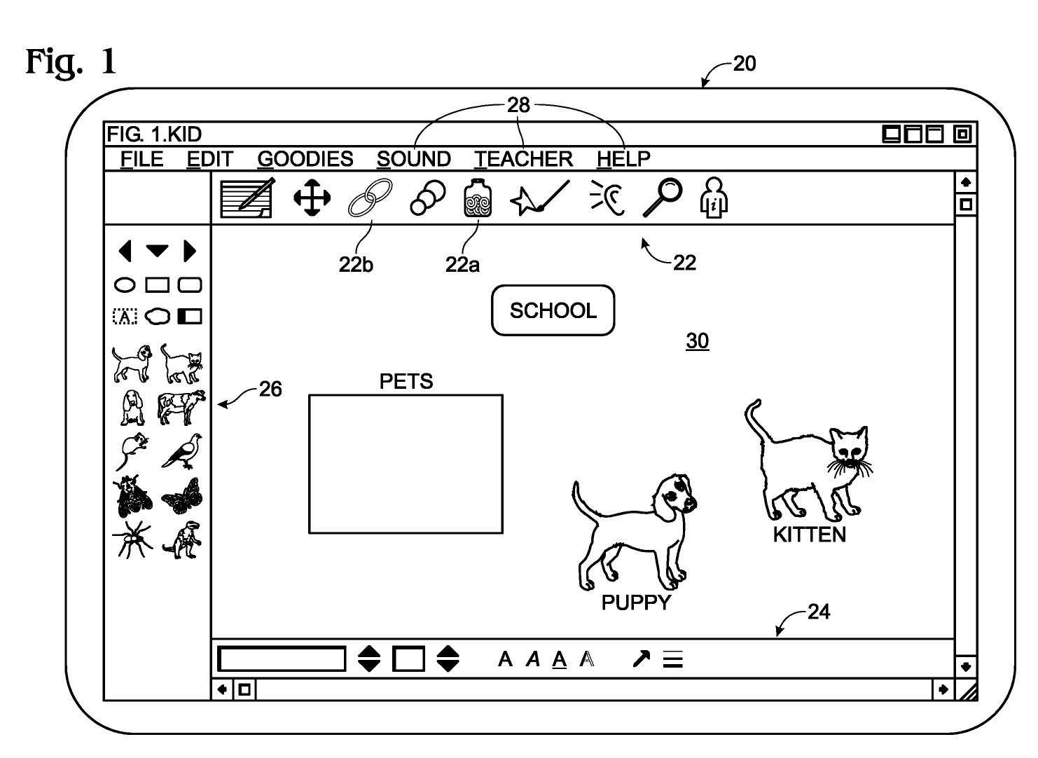

The exemplary implementation includes a graphical user-interface indicated generally at 20 in FIG. 1. User-interface 20 defines a variety of control elements including a tool bar 22, a formatting bar 24, and a symbol library 26, in addition to one or more pull-down menus 28. The control elements are positioned about a graphic workspace 30, and are operable by a child to select, create, identify, define, modify, format, arrange, group, link, categorize, etc., a plurality of graphic symbols representing diverse concepts and ideas.

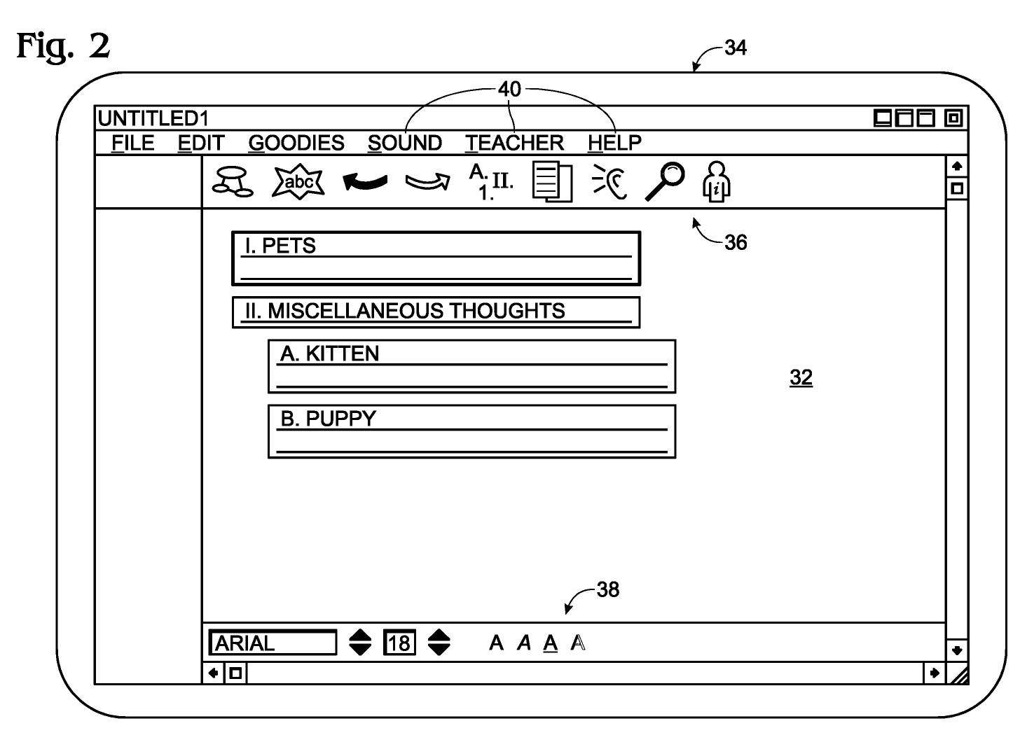

Graphic workspace 30 corresponds to a corresponding textual workspace 32, which is provided by a non-graphical user-interface indicated generally at 34 in FIG. 2. Non-graphical user-interface 34 also defines a variety of control elements including a tool bar 36, a formatting bar 38, and a plurality of pull-down menus 40. Each concept and idea that is represented by a graphic symbol in workspace 20 is also displayed in a textual form in workspace 34. Additions, deletions, and modifications to the graphical symbols in workspace 20 are automatically implemented in corresponding workspace 34. Likewise, additions, deletions, and modifications to the textual symbols in workspace 34 are automatically implemented in corresponding workspace 20.

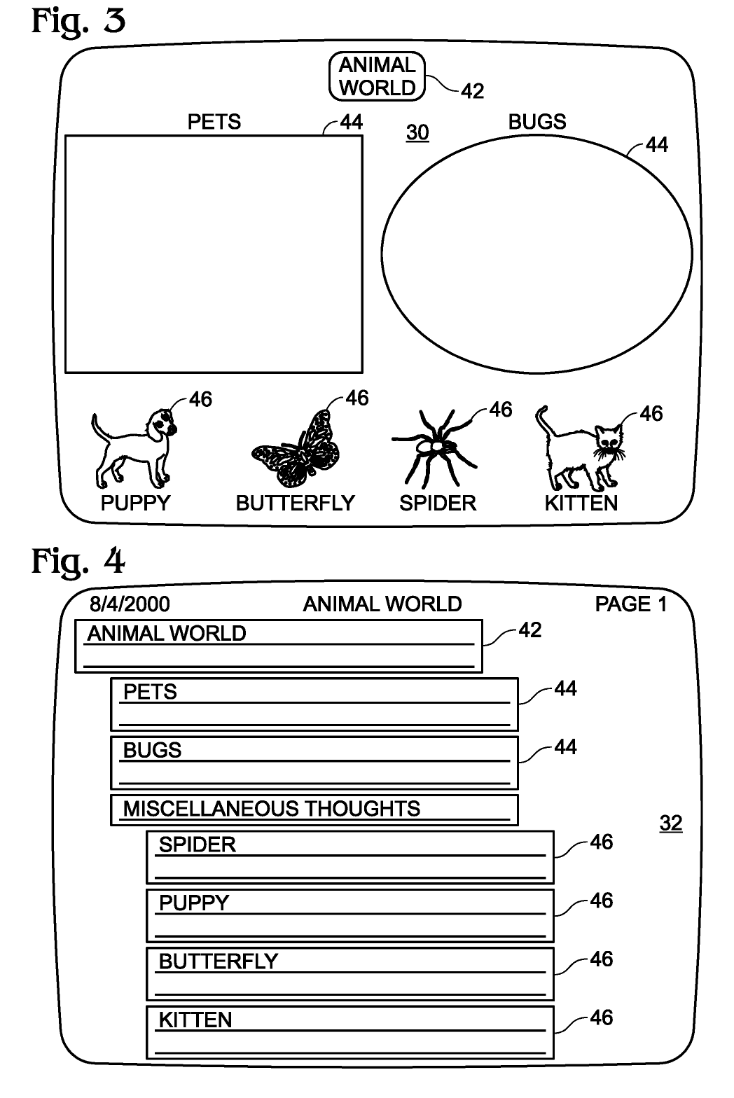

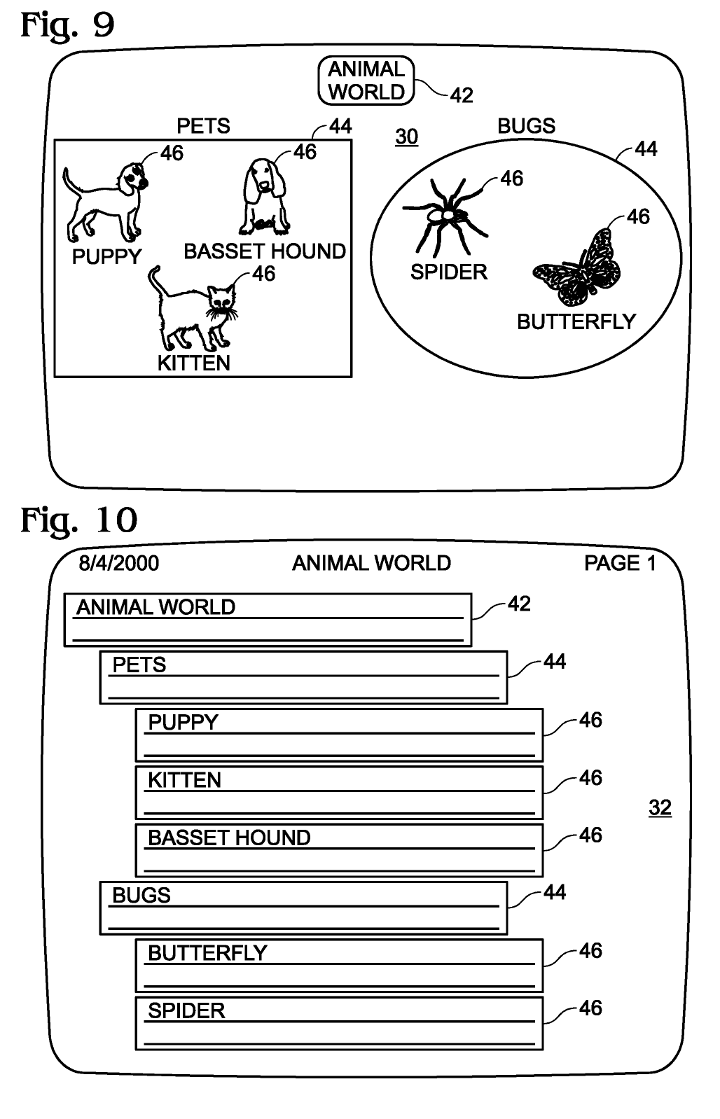

To illustrate some of the features and capabilities of the present invention, FIGS. 3-10 illustrate one example of a method for using the invention to create a logical hierarchy of related concepts. Turning attention first to FIG. 3, a user (e.g., a child) defines a main concept by labeling a title icon 42. Alternatively, title icon may be omitted where multiple unrelated concepts will be included within a single workspace. In any event, the user then operates a grouping tool 22a from tool bar 22 to place one or more grouping objects 44 in workspace 20.

If desired, various characteristics of a selected grouping object may be specified or changed. For example, each grouping object may be labeled by the user. The grouping object labels appear in both the graphical and non-graphical workspaces. Similarly, formatting bar 24 is operable by the user to control the type, style and size of the label font, as well as the colors of the grouping object. A grouping object shape selection tool in pull-down menus 28 allows the user to select one of a plurality of shapes for the grouping object such as a circle, rectangle, star, bag, box, house, shopping cart, person, etc. Further, the size of each grouping object may be adjusted by selecting an edge of the object and moving it closer or farther away from the opposite edge. Typically, the user selects and moves the object using a mouse or similar input device connected to the computer system.

Symbol library 26 in graphical user-interface 20 is usable to select a plurality of graphical concept symbols 46. In the exemplary embodiment, symbols 46 are in the form of photographs of specific objects. However, it will be appreciated that symbols 46 may take any one or more different forms or combinations of different forms including drawings, icons, sounds, images, etc., which are adapted to represent specific concepts, ideas or objects. The symbol library may be configured to store and maintain a large number of different symbols representing a large number of different types of concepts and objects. Just a few examples include: animals, people, science, history, geography, art, math, etc.

A user places a concept symbol in workspace 20 by locating the desired symbol in library 26, and operating the mouse to move a copy of the symbol from the library to the workspace. Each symbol is configured to be associated with an identifying label which is composed by the user. In the workspace depicted in FIG. 3, the concept symbols are each placed outside the grouping objects. As a result, no relationships are formed among the symbols and/or grouping objects. This is illustrated by the non-graphical user-interface illustrated in FIG. 4, which corresponds to the graphical user-interface illustrated in FIG. 3. As shown in FIG. 4, each grouping object and concept symbol is represented by a textual object. The textual objects are arranged in a logical hierarchy corresponding to relationships specified by the user.

In FIG. 4, grouping objects 44 are arranged separately and at a lower hierarchical level from title icon 42. Similarly, the grouping objects are arranged separately and at a higher hierarchical level from concept symbols 46. In the exemplary embodiment, the concept symbols are arranged in a hierarchical level labeled “Miscellaneous Thoughts,” to emphasize the separation from the concept symbols and the grouping objects. Alternatively, the concept symbols may be partitioned from the grouping objects by other suitable means to indicate the absence of any relationships.

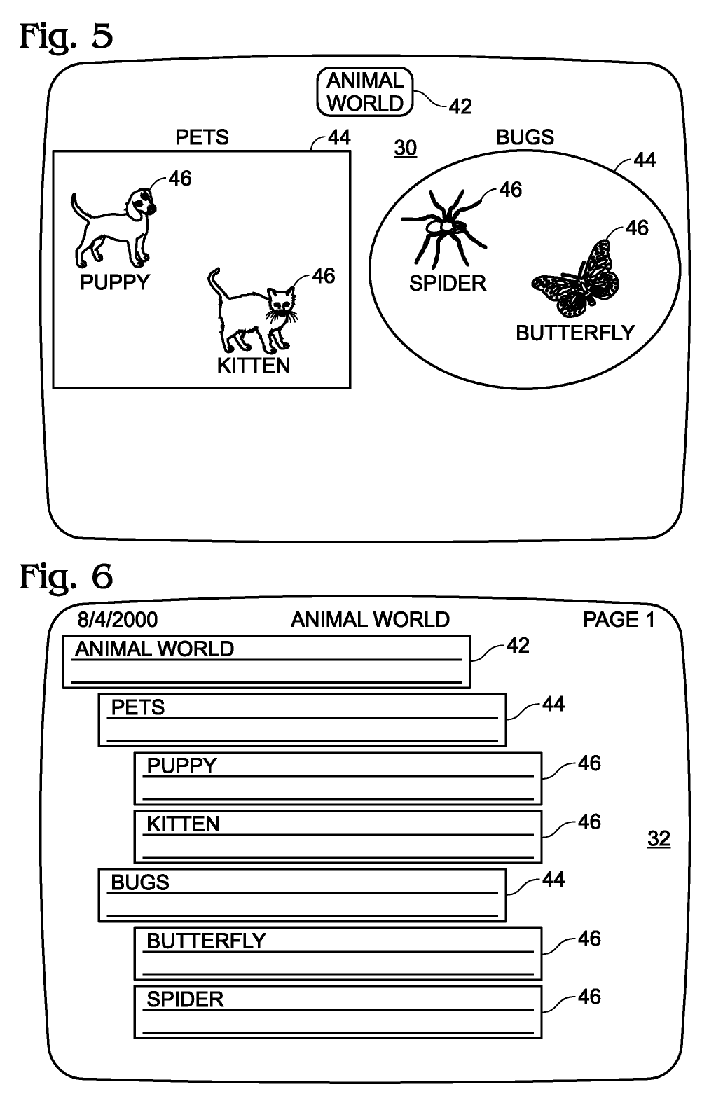

Turning attention now to FIGS. 5 and 6, each grouping object defines a spatial region of workspace 20 and a logical region of workspace 34. Concept symbols within the spatial region of a particular grouping object are associated with that grouping object both graphically (in workspace 20) and logically (in workspace 34). For example, in FIG. 5, the PUPPY and KITTEN concept symbols have been placed within the PETS grouping object, and the BUTTERFLY and SPIDER concept symbols have been placed within the BUGS grouping object. This graphical relationship automatically creates a corresponding logical relationship which is shown in FIG. 6, where the PUPPY and KITTEN concepts are hierarchically arranged under the PETS group. Similarly, the BUTTERFLY and SPIDER concepts are hierarchically arranged under the BUGS group.

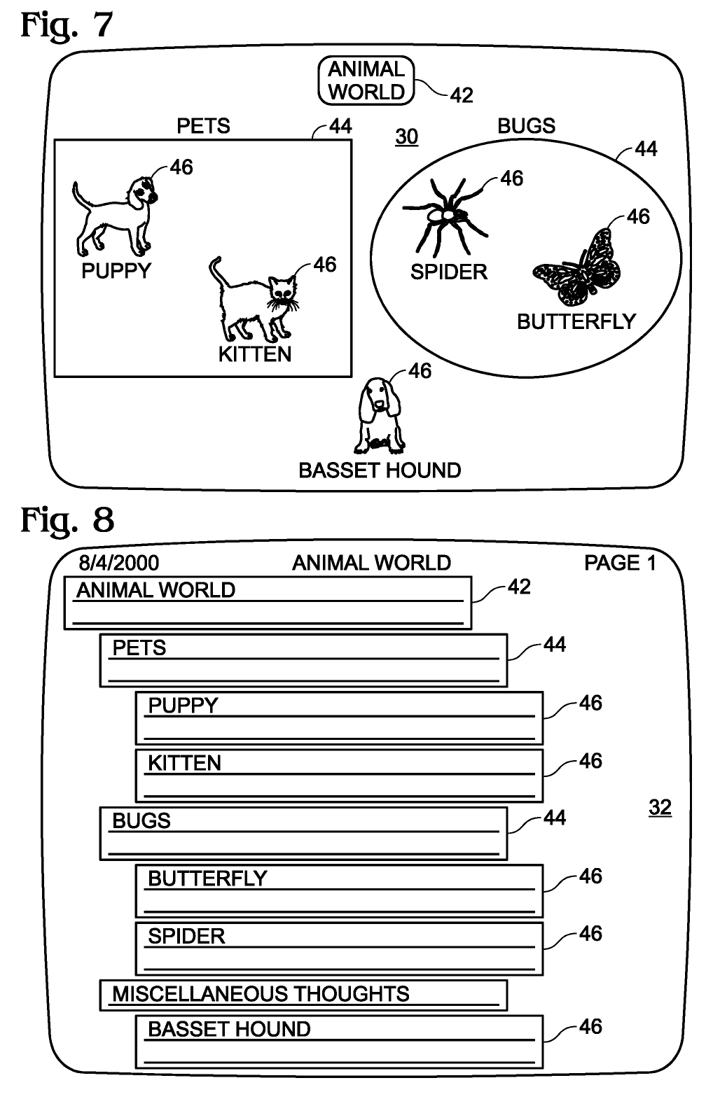

As shown in FIGS. 7-10, new concept symbols may be added from the concept symbol library, and then placed within a selected grouping object to associate the new concept with the existing concept. It should be noted that a concept symbol may be associated with a selected grouping object by moving the concept symbol into the spatial region defined by the grouping object (as shown in FIG. 5), or by moving the grouping object so that the spatial region it defines includes the concept symbol (as shown in FIG. 7). In the latter case, all concept symbols which are already associated with the grouping object are carried along with the grouping object, thereby preserving the association. In other words, once placed within the spatial region defined by a grouping object, a concept symbol becomes graphically as well as logically linked to the spatial region and grouping object.

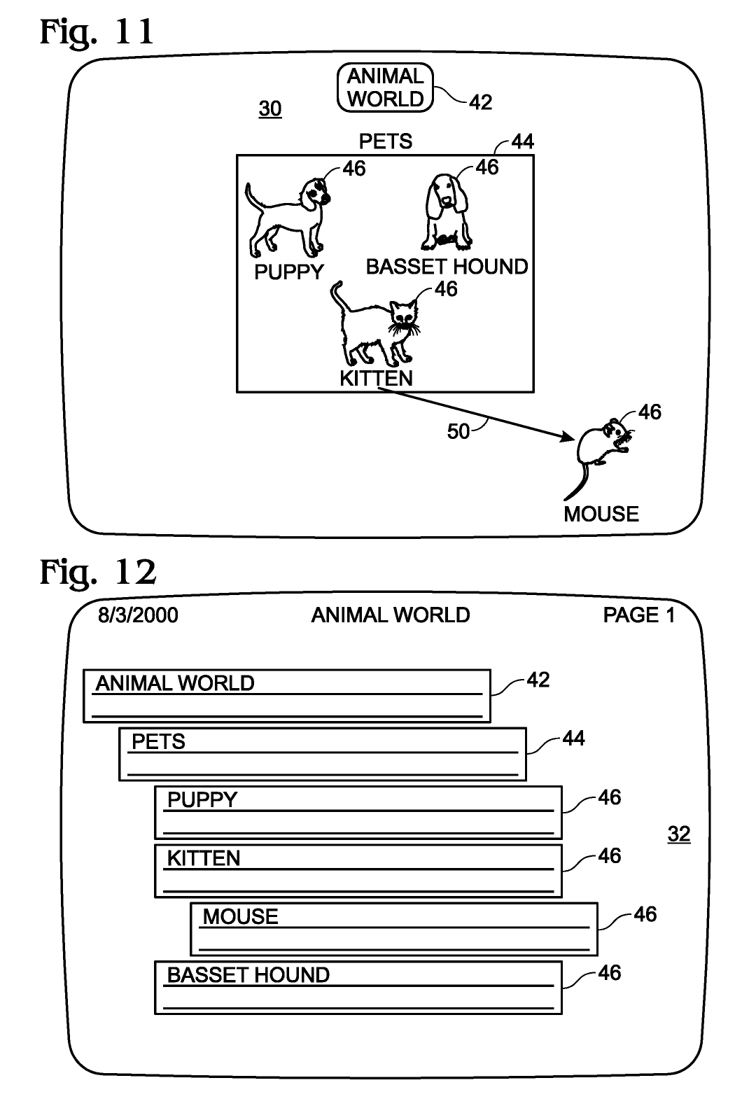

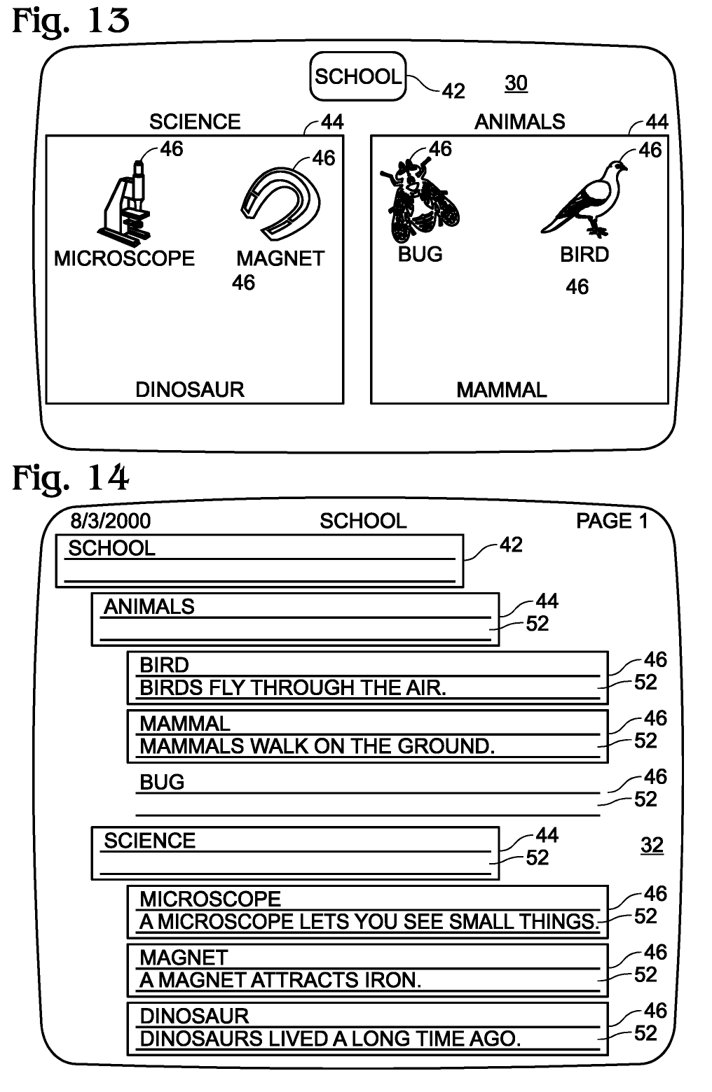

As shown in FIGS. 11 and 12, logical links may be formed between concept symbols 46 which are not within the same grouping object. Tool bar 22 of user-interface 20 includes a linking tool 48 that is operable by a user to create a graphical link 50 in the form of an arrow between two concept symbol. Link 50 is a hierarchical link such that the concept symbol adjacent the arrowhead is logically categorized as a subset of the concept symbol opposite the arrowhead. This relationship is depicted in the corresponding non-graphical user-interface depicted in FIG. 12. In one embodiment, links 50 may be formed between concept symbols outside a grouping object, inside a grouping object, or inside different grouping objects.

Once the selected concept symbols have been logically categorized, either by spatial association in user-interface 20 or textual association in user-interface 34, the user may develop each concept by adding textual material in user-interface 34. Alternatively, the concepts may be developed prior to being logically categorized. Each grouping object and concept symbol entry in the non-graphical user-interface includes a variable-length text-entry region 52 where the user may enter additional information regarding a particular concept.

As described above, the invention provides a novel method for allowing users such as young children to organize thoughts, concepts, etc. The graphical user-interface allows children to define relationships between various concepts using visual, proximity-based groupings. On the other hand, the non-graphical user-interface transforms the relationships created in the graphical user-interface into a textual context, allowing children to expand upon, and further develop their ideas.

It will be appreciated by those of skill in the art that a software system according to the present invention may have any of a variety of different operating rules and sequences. Thus, while one exemplary listing of rules and sequences is provided below, it will be understood that numerous modifications are within the scope of the invention.

### KS09 Group Tool

### KS09 Group Tool

Goal: Offer a way for kids to easily create a logical grouping of their symbols which (1) is deliberate and obvious; not done just by auto-process, (2) has a text area, (3) is automatic for linking, (4) lets them use different symbols, and (5) shows in the Writing View.

### A. Definitions

1. Picture View
a. General
   (1) Grouping objects are a new class of objects
   (2) Groups can only be created in Picture View
   (3) Groups are created using the Group Tool Action is undoable
   (4) Moving a Grouping object moves all concept symbols associated with it
   (5) Sub symbols act as normal concept symbols within a Group
   (6) Group Shapes
      (a) Default Grouping object is a Rounded Rectangle Uses the same default fill and line as other symbols
      (b) Grouping objects can be one of several special shapes Need to scale well
         (i) Rounded rectangle
         (ii) Circle
         (iii) Rectangle
         (iv) Bin
         (v) Bucket
         (vi) Treasure Chest
         (vii) Basket
         (viii) Brown paper bag (similar to grocery bag)
         (ix) Generic people that can be dressed
         (x) Shopping Cart
         (xi) Dollhouse
         (xii) Empty Picture Frame
      (c) The shape of a Grouping object can be changed by selecting it and then choosing “Group Shape” from the Goodies menu.—See mock up of dialog below
   (2) Links
      (a) Grouping objects cannot be linked to or from.
         (i) Link tool does not allow starting a link from a Grouping object—Although links may begin from sub symbols of a Group
         (ii) Link tool does not allow ending a link on a Grouping object—Although links may begin from sub symbols of a Group
      (b) When a concept symbol is at least 75% enclosed by a Grouping object, a hidden link is automatically created to the sub symbol—Enclosure is measured by visible portions of both the group and the sub symbol
      (c) When an enclosed concept symbol is dragged out of the Group, the hidden link is automatically deleted
      (d) Clicking on a Grouping object with Link tool kills link tool selection
   (3) Display
      (a) Grouping objects display underneath all normal objects and links
      (b) Grouping object has special selection handles See KS12 Symbol Handles spec for specifics
      (c) Grouping objects have a text area ABOVE the shape
         (i) Options for multilined text
(1) Add lines up
(2) Push everything down
(3) Split the difference
   (c) Similarities to normal concept symbols:
      (1) Grouping objects can be moved and resized just like normal concept symbols
      (2) The fill/line color (or multicolor) can be changed just like any concept symbol
      (3) Existing links to or from sub symbols within a Group behave as normal links
      (4) Grouping objects can be selected or multiselected just like any other concept symbol

2. Writing View
a. General
   (1) Groups cannot be created in Writing view
   (2) Groups appear at the level of the Main Idea
   (3) Group labels can be edited
b. Moving Subtopics of a Group
   (1) Subtopics of a Group may be moved, or have subtopics themselves
   (2) If you move a subtopic out of a Group, the sub symbol needs to move in the Picture view so that the sub symbol is not in any Grouping object
   (3) If you add topics to a Group or move topics into a Group then, in Picture view, the symbols must fit within the existing Grouping object dimensions (they can overlap each other and no auto growing of Grouping object is allowed)
   (4) Moving new topics into or out of the root level of a Group physically moves the symbol into or out of the group in the Picture view
   (5) Moving subtopics at non-root level does not physically move the sub symbols in he Picture view, but rather creates a standard link
c. Creating Subtopics of a Group
   (1) Creating new topics at the root level of a Group creates a new symbol and places it within the Group in the Picture view
   (2) Creating subtopics at non-root level creates a new symbol outside the Group with a standard link

### B. Interface

1. “Group Tool” button on Top toolbar in Picture view which when selected changes to a custom cursor

2. User clicks and drags out a “Grouping” selection

3. A “Group” symbol is created at the size that the user dragged out

4. Any symbols that are enclosed (at least 75%) by the “Grouping” selection are automatically added as sub symbols to the Grouping object

5. If no symbols are enclosed, then an empty Grouping object will be created at the size dragged

6. Clicking on an empty region of the picture kills Group Tool selection Can also turn off Group tool by reclicking on Group tool button

7. “Group Shades” dialog from the Goodies menu serves two functions:
a. If no Grouping object in the Picture is selected upon entering the “Group Shapes” dialog, picking a shape from the dialog only sets the default Group shape. Dismissing the dialog by clicking the OK button activates the Group tool
b. If a Grouping object in the Picture is selected upon entering the “Group Shapes” dialog, picking a shape from the dialog changes the shape of the currently selected Grouping object (after clicking OK to dismiss dialog) and sets the Group shape default
   (1)
      (a) 8 previews in window at any given time Size of previews=approximately 100 pixels by 100 pixels
      (b) Scrolling enabled if more than 8 choices
      (c) Text area under each Shape indicating name of Group Shape
      (d) Double-clicking to select a shape is allowed
      (e) OK button—After selecting Group shape, OK sets default and dismisses dialog
      (f) Cancel button—Keeps current Group default
      (g) Standard dialog behavior
         (i) Click down and hold allows user to scroll between choices
         (ii) Mouse up on a shape selects that shape
      (h) For all non-Grouping objects that are selected, choosing a shape from this dialog only sets the default Groups shape and changes Group shapes, but has no effect on anything else
      (i) Menu is always enabled
      (j) Should be undo-able

### C. Overlapping Grouping Objects

1. The Grouping objects are analyzed from top to bottom in the Z order Transparency is honored for determining Z order

2. There is no such thing as a subgroup

3. Overlapped areas of Groups could be drawn showing translucence through the top level Group

4. Moving Groups on top of preexisting concept symbols: Releasing the mouse adds the concept symbols to the top-most Group

5. Sub symbols which overlap more than one Grouping object belong to the top most Grouping object

6. When a Grouping object is selected, it is brought to the top of the layering for the Grouping objects
a. When the layering of Grouping objects changes, which concept symbols belong to which Group is reanalyzed and possibly the concept symbols may change from one Group to another (concept symbols won't physically move)

### D. Deleting a Group

1. In Picture view, all symbols contained in the Group remain

2. In Writing view, dialog asks are you sure? (this is the existing message)

### E. Undo

1. Should be undo-able
a. Creating a Group with the Group tool
b. Deleting a Group in both Picture and Writing views
c. Changing the shape of an existing Group
d. Changing fill and line colors of a Group
e. Resizing a Group
f. Moving a Group and its sub symbols Sub symbols move with he Group when move is undone
g. Moving a Group to the top of the Z order by means of selection
h. Moving a sub symbol into or out of the Group
   This also means that both creating and breaking a hidden link is undo-able

2. Not undo-able
a. Setting the Group shape default is not undo-able

We claim:

1. A computer-implemented system for assisting children in organizing and categorizing information, comprising:
a computer program, operable with a computer system, that includes a dual graphical and non-graphical user-interface that is operable by a child to create and identify a variety of concepts, and to organize and arrange those concepts in a non-graphical hierarchy by creating spatial associations using the graphical user-interface.

2. A computer-implemented method for assisting children in organizing and categorizing information, comprising:
providing a computer program that is operable with a computer system, and that includes a dual graphical and non-graphical user-interface that is operable by a child to create and identify a variety of concepts, and to organize and arrange those concepts in a non-graphical hierarchy by creating spatial associations using the graphical user-interface.
